(19) United States
(12) Patent Application Publication
(10) Pub. No.: US 2012/0086196 A1
(43) Pub. Date: Apr. 12, 2012

(54) CONDUIT COUPLING WITH REMOVABLE STOP

(76) Inventor: Lawrence J. SMITH, Stamford, CT (US)

(21) Appl. No.: 12/900,848

(22) Filed: Oct. 8, 2010

(51) Int. Cl. F16L 21/00

(52) U.S. Cl. 285/31

(57) ABSTRACT

A coupling for coupling ends of a rigid conduit together having a removable stop. A cylindrical sleeve has a removable stop that permits positioning of the cylindrical sleeve entirely on one end of a conduit having limited axial movement that is being repaired. The cylindrical sleeve is then axially or longitudinally positioned over a gap between the ends of the conduit being repaired and the retractable stop is lowered and positioned within the gap. A window within the cylindrical sleeve facilitates positioning of the retractable stop within the gap. Set screws secure the ends of the conduit within the cylindrical sleeve. Rigid conduit may be repaired without having to disconnect the distant or remote ends of the rigid conduit.

### FIELD OF THE INVENTION

The present invention relates in general to the coupling of electrical conduit, and more particularly to the coupling of electrical conduit with limited axial movement.

### BACKGROUND OF THE INVENTION

Electrical conduit is often used to hold electrical cabling or wires in long runs or lengths. The electrical conduit is usually rigid and may be electrical metallic tubing, EMT, or rigid conduit. The electrical conduit is usually coupled at either end to electrical boxes and is usually securely fixed in position. Occasionally, repairs must be made after the electrical conduit is fully installed and, in a relatively secure or fixed position. When a repair is required and the conduit is already assembled or joined, there would be a need to physically separate the two pieces of conduit sufficiently so that a standard coupling could be used to join the two ends or pieces of conduit together. However, generally there is only a small gap between the ends of the two sections or pieces of conduit with the conduit having very little axial movement due to the distant ends of the conduit being assembled and in a fixed position. While a standard conduit, typically having a fixed central stop, may have one end placed on an end of one of the sections or pieces of conduit, the gap between the conduit sections or pieces is often too small or narrow to permit the other end of the conduit coupling to be placed on the other end of another piece or section of conduit. Therefore, it is often required to remove a distant opposing end of the installed conduit being repaired so as to permit sufficient axial movement thereof. However, this is time-consuming and requires a worker to locate the distant opposing fixed end of the section being repaired, which may be a substantial distance away and may even be inaccessible or difficult to access. This makes the repair of an intermediate or mid-section of an electrical conduit difficult and time-consuming. Therefore, the prior standard couplings having a fixed stop are often difficult to use in repairing electrical conduit. Accordingly, there is a need for an electrical conduit coupling that is easy to use in repairing electrical conduit that is in a fixed position, having limited axial movement.

### SUMMARY OF THE INVENTION

The present invention provides a simple, elegant solution to the repairing of conduit fixed in position and having limited axial movement. The conduit coupling of the present invention comprises a cylindrical sleeve having openings at either end for receiving a conduit. Centrally located on the cylindrical sleeve is a retractable stop. Adjacent the retractable stop is a window. Adjacent either end of the cylindrical sleeve is a set screw used to securely retain ends of electrical conduit therein. By retracting the retractable stop and moving one end of the conduit being repaired laterally, the cylindrical sleeve may be slid on to the conduit past the retractable stop so that another end of the cylindrical sleeve can then be repositioned over the other section or portion of conduit being repaired. The cylindrical sleeve can be moved into position and the retractable stop located within the gap between the two sections of conduit being repaired by viewing through the window adjacent the retractable stop. The retractable stop is then positioned within the gap, preventing axial movement. The set screws are used to secure the ends of both sections of conduit being repaired securely within the cylindrical sleeve.

Accordingly, it is an object of the invention to facilitate the repair of electrical conduit.

It is another object of the invention to repair installed conduit that is fixed in position with limited axial movement.

It is an advantage of the invention that electrical conduit can be repaired without having to remove the attached ends of the conduit so as to obtain axial movement.

It is another advantage of the invention that two sections of an electrical conduit may be coupled when the gap between the two sections of conduit is relatively small.

It is a feature of the invention that a retractable stop is placed substantially midway between the ends of a cylindrical sleeve.

It is another feature of the invention that a window is placed adjacent the retractable stop.

These and other objects, advantages, and features will become more readily apparent in view of the following detailed description.

### BRIEF DESCRIPTION OF THE DRAWINGS

FIG. 1 is a perspective view of the conduit coupling.

FIG. 2 is a plan view of the conduit coupling.

FIG. 3 is an end view of the conduit coupling.

FIG. 4 is a cross-section taken along line 4-4 in FIG. 3.

FIG. 5 schematically illustrates the placement of the conduit coupling on one section of a conduit being repaired.

FIG. 6 schematically illustrates the positioning of the conduit coupling securely coupling two portions or sections of a conduit.

FIGS. 7A-D schematically represent the method steps of coupling two ends or sections of rigid conduit with the conduit coupling of the invention.

### DETAILED DESCRIPTION OF THE PREFERRED EMBODIMENT

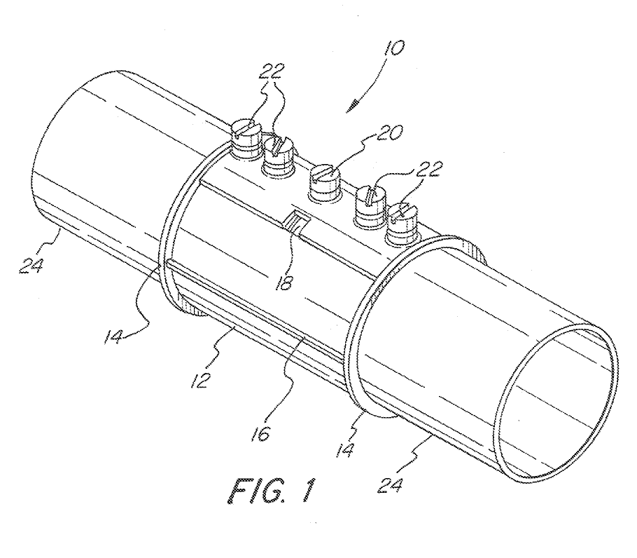

FIG. 1 illustrates the positioning of the conduit coupling 10 on the ends of two sections of conduit 24. The conduit 24 may be any rigid electrical conduit such as electrical metallic tubing or EMT or rigid conduit. A cylindrical sleeve 12 has flanges 14 on either end. A longitudinal rib 16 may be provided to provide rigidity or structural strength to the cylindrical sleeve 12. A window 18 is formed within the cylindrical sleeve 12 adjacent a retractable stop 20. The retractable stop 20 is illustrated as a screw and is positioned substantially mid-way between the ends of the cylindrical sleeve 12. Adjacent either end of the cylindrical sleeve 12 is a mechanical fastener or set screws 22. Set screws 22 are placed within tapped holes formed within the cylindrical sleeve 12. A mechanical fastener or the set screws 22 are used to secure the ends of the conduit 24 placed within either end of the cylindrical sleeve 12.

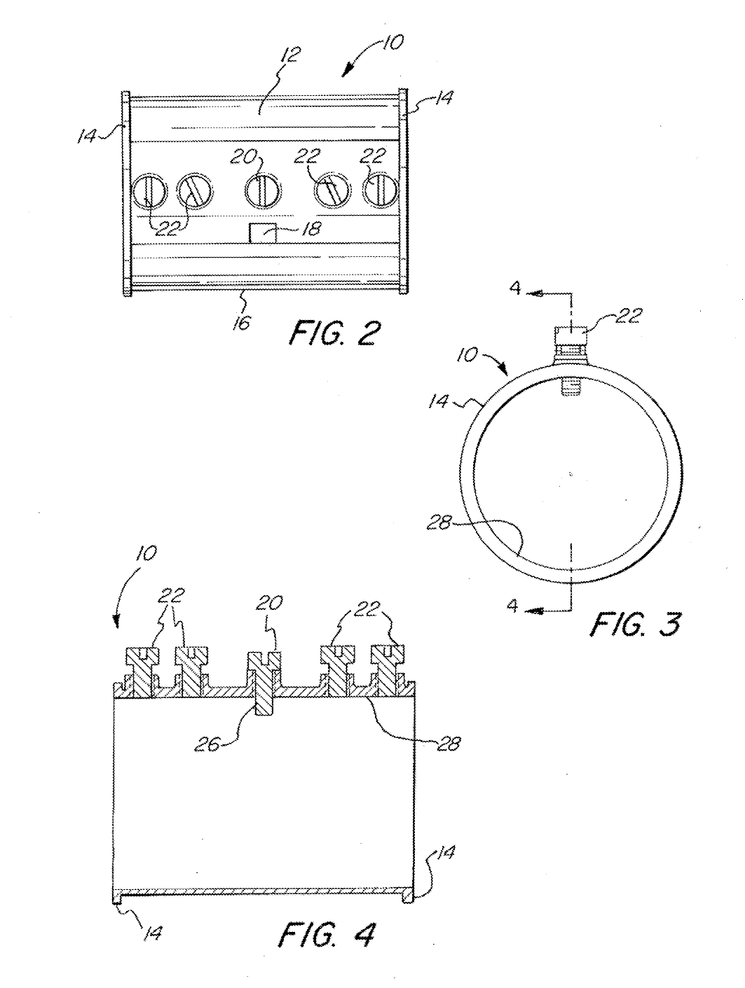

FIG. 2 is a plan view clearly illustrating the positioning of the retractable stop 20 and the window 18. The window 18 is placed adjacent the retractable stop 20 and provides a clear view into the interior of the cylindrical sleeve 12.

FIG. 3 illustrates the cylindrical shape of the conduit coupling 10 and the inner bore 28. The set screw 22 is illustrated extending into the bore 28.

FIG. 4 is a cross-section taken along line 4-4 of FIG. 3 and more clearly illustrates the retractable stop 20 and the retractable stop end 26 extending into the inner bore 28 substantially mid-way along the axial or longitudinal length of the conduit coupling 10.

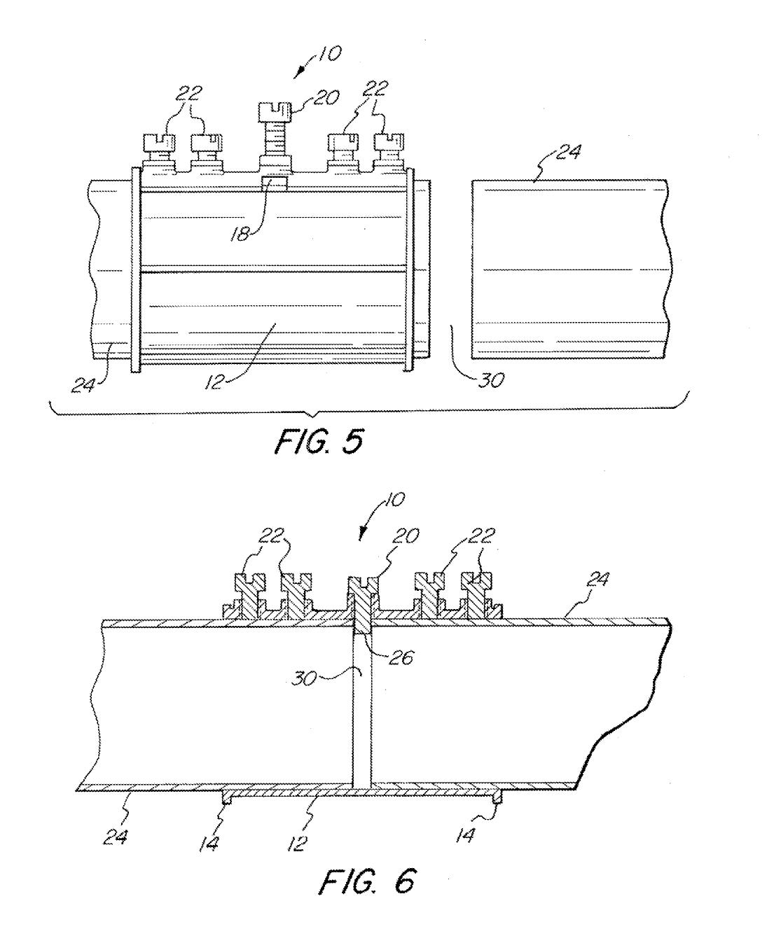

FIGS. 5 and 6 schematically illustrate the positioning of the conduit coupling 10 on to two end sections of a conduit 24 having a gap 30 there between. FIG. 5 illustrates the conduit coupling 10 placed in an intermediate position on one end of one of the conduits 24 with the retractable stop 20 in a retracted position so as not to contact the conduit 24 on which the cylindrical sleeve 12 is placed. Window 18 is placed adjacent the retractable stop 20 and provides a view through which the conduit 24 can be seen. Window 18 permits the gap 30 to be easily viewed and located and provides assurance that the retractable stop 20 is properly positioned and inserted into the gap 30.

FIG. 6 illustrates the final position of the conduit coupling 10 axially slid over so as to be centered over the gap 30 securely coupling the two portions of the conduit 24 together. The end of the retractable stop 26 is placed in position over and within the gap 30 preventing any possibility of axial or longitudinal shifting of the conduit coupling 10. Set screws 22 are tightened and used to securely hold the ends of the conduit 24 within the conduit coupling 10.

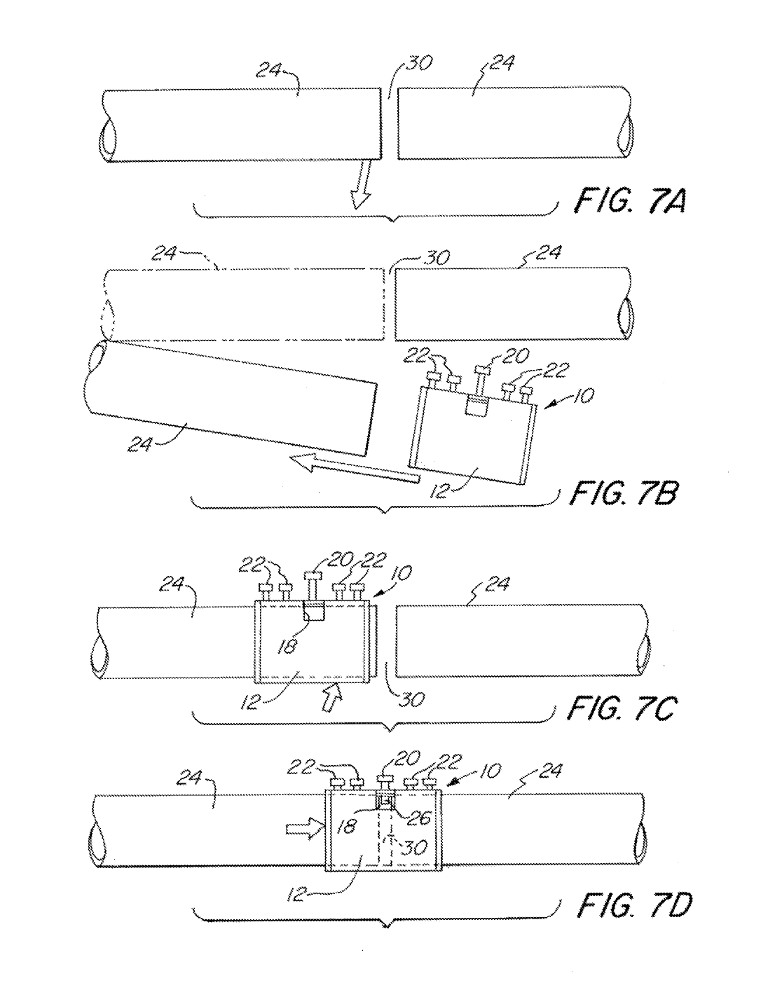

FIG. 7A-7D schematically illustrates the method, steps, or acts utilized in the invention. FIG. 7A illustrates two sections of conduit 24 separated by a gap 30 that has been repaired and now must be coupled together. The distant ends, not shown, of the two section of conduit 24 are typically coupled to other conduits or electrical boxes or fixtures and therefore the conduits 24 have very limited movement in the axial direction. Therefore, gap 30 generally cannot be made larger or widened. FIG. 7B illustrates the method, step, or act of laterally displacing one of the conduits 24 sufficiently past the other conduit end to permit the conduit coupling 10, with the retractable stop 20 and the set screws 22 on sleeve 12 retracted, so as to permit easy sliding of the conduit coupling 10 on to the laterally displaced end of one of the conduit 24. The conduit coupling 10 is placed entirely onto one end of one of the conduits 24 so that one end of the conduit coupling 10 is aligned with or past the one end of the conduit 24. FIG. 7C illustrates a method, step, or act of positioning or sliding the conduit coupling 10 entirely on one end of one of the conduits 24 and repositioning the laterally displaced conduit 24 co-axially or in a position in axial alignment with the other adjacent section of conduit 24, reforming the gap 30 between the two portions or sections of conduit 24. FIG. 7D illustrates the method, step, or act of displacing in an axial direction or sliding the conduit coupling 10 centrally over the gap 30. The gap 30 may be viewed through window 18 so as to reposition the retractable stop 20 within the gap 30 between the ends of the conduit 24. The retractable stop 26 is then lowered or positioned within the gap 30 so as to prevent any movement in the axial direction of the conduit coupling 10. The set screws 22 may then be securely fastened on either end of the conduits 24 engaging or fixing the ends of the conduits 24 securely together within the conduit coupling 10.

Accordingly, as illustrated in FIGS. 7A-7D, the positioning of the conduit coupling 10 into position so as to securely hold and couple the ends of the conduits 24 can be accomplished without any axial displacement or movement in an axial direction of the conduits 24. Therefore, the distant fixed ends of the conduits 24 need not be disassembled or removed to facilitate repair of a portion of the conduits 24. This saves considerable time and effort in repairing a portion of a conduit 24 that has already been secured in place.

The invention may appear relatively simple; however it saves considerable time and aggravation when a repair of a rigid conduit is required. The invention permits the repair of an in-position rigid conduit quickly and easily, advancing the art of conduit couplings.

While the invention has been described with respect to a preferred embodiment, it will be obvious that various modifications may be made without departing from the spirit and scope of this invention.

What is claimed is:

1. A conduit coupling for attaching ends of a conduit having limited axial movement together comprising:
a cylindrical sleeve;
a retractable stop placed intermediate the ends of said cylindrical sleeve; and
a mechanical fastener placed adjacent each end of said cylindrical sleeve, whereby said cylindrical sleeve can be securely attached to the ends of the conduit,
whereby the ends of the conduit may be securely coupled together without un-attaching a distant attached end of the conduit.

2. A conduit coupling for attaching ends of a conduit having limited axial movement together as in claim 1 further comprising:
a window formed in said cylindrical sleeve.

3. A conduit coupling for attaching ends of a conduit having limited axial movement together as in claim 2 wherein:
said window is placed adjacent said retractable stop.

4. A conduit coupling for attaching ends of a conduit having limited axial movement together as in claim 1 wherein:
said retractable stop comprises a screw.

5. A conduit coupling for attaching ends of a conduit having limited axial movement together as in claim 1 wherein:
said mechanical fastener comprises at least one set screw placed adjacent each end of said cylindrical sleeve.

6. A conduit coupling for attaching ends of a conduit having limited axial movement together as in claim 5 wherein:
said at least one set screw comprises two set screws.

7. A conduit coupling for attaching ends of a conduit having limited axial movement together as in claim 1 further comprising:
longitudinal ribs formed on said cylindrical sleeve.

8. A conduit coupling for attaching ends of a conduit having limited axial movement together comprising:
a cylindrical sleeve having a first and second end;
a retractable stop screw placed intermediate the first and second ends of said cylindrical sleeve;
a window placed adjacent said retractable stop screw; and
at least one set screw placed adjacent each of the first and second ends of said cylindrical sleeve, whereby the first and second ends of said cylindrical sleeve are securely attached to the ends of the conduit,
whereby the ends of the conduit may be securely coupled together without un-attaching a distant attached end of the conduit.

9. A conduit coupling for attaching ends of a conduit having limited axial movement together as in claim 8 further comprising:
longitudinal ribs formed on said cylindrical sleeve.

10. A method of attaching a conduit coupling to ends of a conduit having limited axial movement comprising the steps of:
placing a first and second conduit end adjacent one another forming a gap therebetween;
retracting a retractable stop on a cylindrical sleeve;
retracting a mechanical fastener placed on each end of the cylindrical sleeve;
laterally displacing the first conduit end past the second conduit end;
sliding the cylindrical sleeve entirely onto the first conduit end;
repositioning the first conduit end to a position in axial alignment with the second conduit end reforming the gap therebetween;
sliding the cylindrical sleeve from the first conduit end partially onto the second conduit end;
aligning the retractable stop within the gap between the first and second conduct ends;
inserting a portion of the retractable stop into the gap between the first and second conduct ends, whereby axial movement of the cylindrical sleeve is prevented; and
securing the mechanical fastener placed on each end of the cylindrical sleeve into engagement with a respective one of the first and second conduit ends,
whereby the ends of the conduit may be securely coupled together without un-attaching a distant attached end of the conduit.

11. A method of attaching a conduit coupling to ends of a conduit having limited axial movement as in claim 10 further comprising the step of:
viewing the conduit end through a window during said step of aligning the retractable stop within the gap between the first and second conduit ends.
